(19) United States
(12) Patent Application Publication
(10) Pub. No.: US 2026/0280111 A1
(43) Pub. Date: Sep. 17, 2026

(54) HOUSING

(71) Applicant: ALPHA NETWORKS INC., Hsinchu (TW)

(72) Inventors: SHIH-CHIEH SU, Hsinchu (TW); YI-PENG CHENG, Hsinchu (TW); CHIA-YING YANG, Hsinchu (TW); MING-FENG LIN, Hsinchu (TW)

(73) Assignee: ALPHA NETWORKS INC., Hsinchu (TW)

(21) Appl. No.: 19/272,264

(22) Filed: Jul. 17, 2025

(30) Foreign Application Priority Data
Mar. 14, 2025 (TW) 114109688

(51) Int. Cl. H01Q 1/42; G01V 3/08

(52) U.S. Cl. CPC H01Q 1/42; G01V 3/088

(57) ABSTRACT

A housing is adapted to install an electronic device and includes an outer housing which the electronic device disposed in, a water drop sensing module located in the outer housing and including a first water drop sensor, and a control device electrically connected to the first water drop sensor and the electronic device. An outer surface of the outer housing has a sensing area. The water drop sensing module is disposed on an inner surface of the outer housing corresponding to the sensing area. When a water drop touches the sensing area corresponding to the first water drop sensor, the first water drop sensor outputs a first sensing signal to the control device. The control device transmits a first notifying signal to the electronic device according to the first sensing signal. The electronic device adjusts at least one device parameter according to the first notifying signal.

### BACKGROUND OF THE INVENTION

### Technical Field

The present invention relates generally to a housing, and more particularly to a housing with a water drop sensing module.

### Description of Related Art

With the technology evolving, it is known that the networks have been a necessary part of the daily livings of persons. The networks are categorized into a wired network and a wireless network according to the connections of the networks. Due to a diversity and a popularization of the mobile devices (e.g., cell phone, laptop, etc.) with a wireless network connection function and the intelligent appliances (e.g., security system, appliance, etc.), a demand of the wireless base stations gradually increases.

An outdoor wireless base station is under more environmental constraints than an indoor wireless base station. For example, a housing of the outdoor wireless base station needs to be water-proof and dust-proof to withstand the outdoor environmental changes such as rainfall. However, a wireless signal emitted by the conventional outdoor wireless base station is usually affected through a rain fade. In other words, because a plurality of raindrops absorb or scatter the wireless signal, a fade of the wireless signal is generated, so that a quality of the wireless signal is reduced. Therefore, to improve the reduced quality of the wireless signal caused by the rain fade, how to adjust the parameters of the wireless signal corresponding to the rainfall, is a problem needed to be solved.

### BRIEF SUMMARY OF THE INVENTION

In view of the above, the primary objective of the present invention is to provide a housing, which could sense a rainfall condition and correspondingly adjust at least one device parameter of an electronic device.

The present invention provides a housing adapted to install an electronic device, wherein the electronic device has at least one device parameter. The housing includes an outer housing, a water drop sensing module, and a control device, wherein the electronic device is disposed in the outer housing. An outer surface of the outer housing has at least one sensing area. The water drop sensing module is disposed on an inner surface of the outer housing corresponding to the at least one sensing area and is located in the outer housing. The water drop sensing module includes at least one first water drop sensor. When a water drop is in contact with the at least one sensing area corresponding to a location of the at least one first water drop sensor, the at least one first water drop sensor correspondingly outputs a first sensing signal. The control device is electrically connected to the at least one first water drop sensor and the electronic device. The control device receives the first sensing signal and transmits a first notifying signal to the electronic device according to the first sensing signal. The electronic device adjusts the at least one device parameter according to the first notifying signal.

With the aforementioned design, through the water drop sensing module, the rainfall condition could be transformed into the corresponding first sensing signal. The control device receives the first sensing signal and transmits the first notifying signal to the electronic device according to the first sensing signal, so that the electronic device adjusts the at least one device parameter according to the first notifying signal. Therefore, the at least one device parameter could be properly adjusted according to the rainfall condition, thereby improving a rain fade of the electronic device.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the housing according to an embodiment of the present invention;

FIG. 2 is a perspective view of the housing seen from another direction according to the embodiment of the present invention;

FIG. 3 is a schematic view of a part of the housing according to the embodiment of the present invention;

FIG. 4 is a schematic view of the first water drop sensor according to the embodiment of the present invention;

FIG. 5 is a schematic view of a part of the housing, showing the water drop in contact with the outer housing corresponding to the location of the first water drop sensor according to the embodiment of the present invention;

FIG. 6 is a schematic view of a second water drop sensor according to the embodiment of the present invention; and

FIG. 7 is a schematic view of a part of the housing, showing the water drop in contact with the outer housing corresponding to a location of the second water drop sensor according to the embodiment of the present invention.

### DETAILED DESCRIPTION OF THE INVENTION

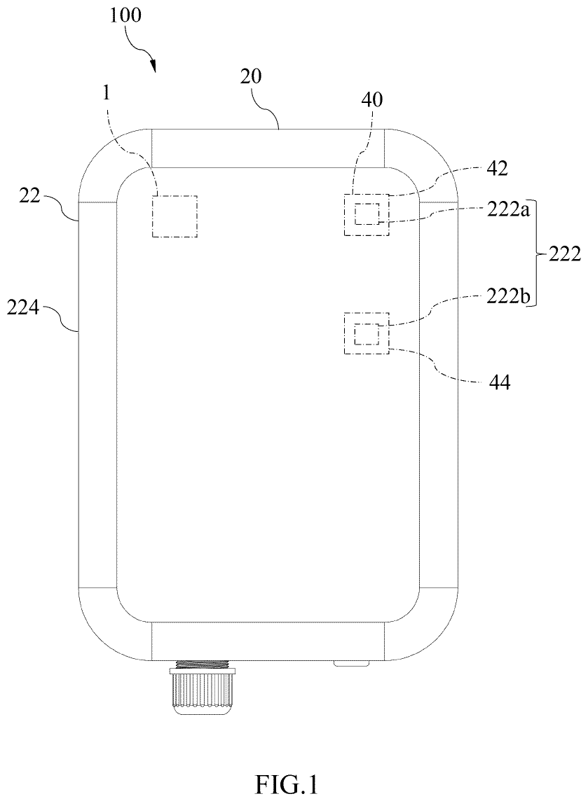

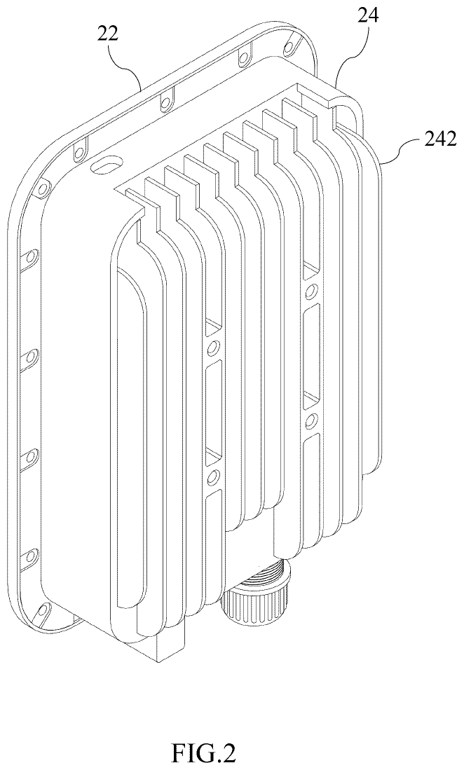

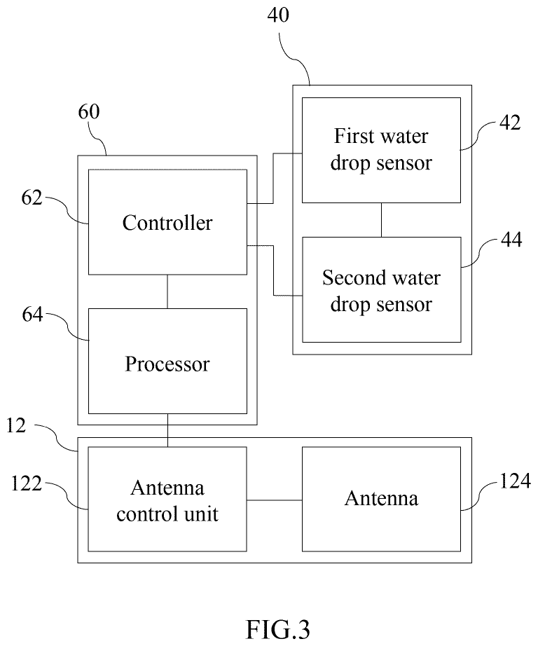

A housing 100 according to an embodiment of the present invention is illustrated in FIG. 1 to FIG. 3. The housing 100 is adapted to install an electronic device 1 and includes an outer housing 20, a water drop sensing module 40, and a control device 60. The electronic device 1 has at least one device parameter. In the current embodiment, the electronic device 1 is an antenna module 12, wherein the antenna module 12 includes an antenna control unit 122 and an antenna 124. The antenna control unit 122 is electrically connected to the antenna 124. The antenna 124 is adapted to emit a wireless signal and has the at least one device parameter corresponding to the wireless signal. The antenna control unit 122 is adapted to control the antenna 124 to adjust the at least one device parameter. In the current embodiment, the at least one device parameter could be one of a transmit power, a transmission rate, a transmission interval, and a packet size or any combination of two or more thereof, but not limited thereto.

The antenna module 12 is disposed in the outer housing 20. The outer housing 20 is formed through a first housing body 22 combined with a second housing body 24. An outer surface of the first housing body 22 has at least one sensing area 222 and an emission surface 224. The wireless signal of the antenna 124 passes through the emission surface 224. The emission surface 224 and the at least one sensing area 222 are located on the same side of the outer housing 20. The at least one sensing area 222 includes at least one first sensing area 222a and at least one second sensing area 222b. A location of the at least one first sensing area 222a is not identical to a location of the at least one second sensing area 222b. The second housing body 24 has a plurality of fins 242, wherein the fins 242 are adapted to cool a plurality of electronic components located in the outer housing 20, such as the water drop sensing module 40, the control device 60, and the antenna module 12. In the current embodiment, the first housing body 22 is made of plastic to allow the wireless signal to pass through the first housing body 22. The second housing body 24 is made of metal, but not limited thereto. In other embodiments, the at least one first sensing area 222a and the at least one second sensing area 222b could be disposed on two or more sides of the outer housing 20 only if the outer housing 20 on which the at least one first sensing area 222a and the at least one second sensing area 222b are disposed is made of the insulated material such as plastic, etc.

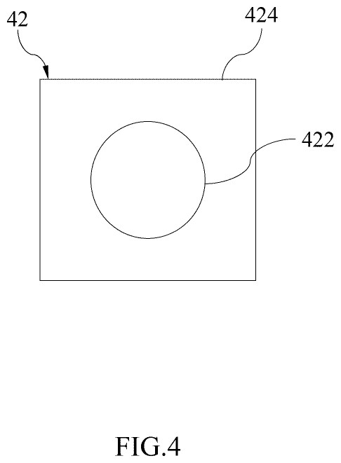

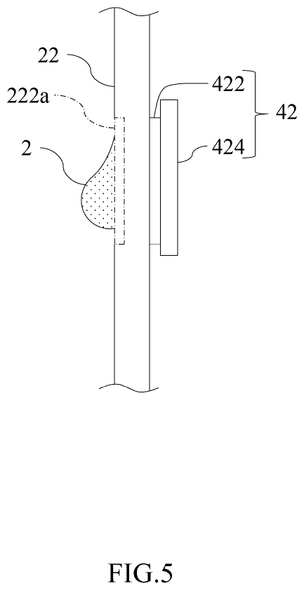

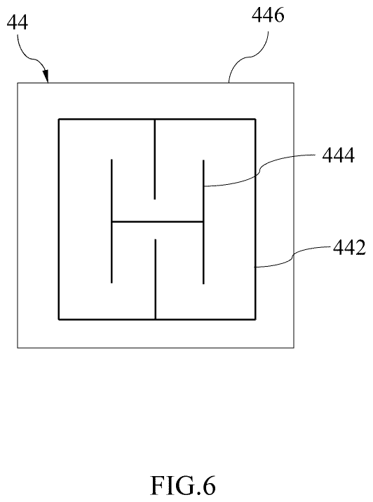

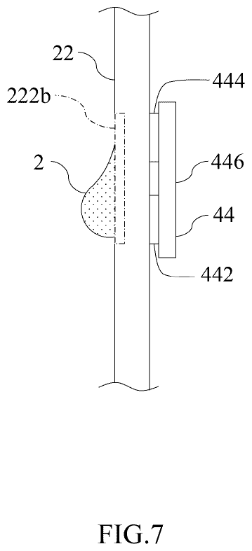

Referring to FIG. 4 to FIG. 7, the water drop sensing module 40 is disposed on an inner surface of the outer housing 20 corresponding to the at least one sensing area 222 and is located in the outer housing 20. The water drop sensing module 40 includes at least one first water drop sensor 42 and at least one second water drop sensor 44. In the current embodiment, the at least one first water drop sensor 42 is at least one self capacitor sensor and includes a first sensing component 422 and a first circuit board 424, wherein the first sensing component 422 is disposed on the first circuit board 424 and has a first capacitance variation value. A location of the at least one first sensing component 422 corresponds to the location of the at least one first sensing area 222a. When a water drop 2 is in contact with the at least one first sensing area 222a corresponding to the location of the first sensing component 422 of the at least one first water drop sensor 42, the water drop 2, the first housing body 22, and the first sensing component 422 form a conductive path of an equivalent capacitor because of the water drop 2 being a conductor, so that a capacitance value of the first sensing component 422 changes by the first capacitance variation value to correspondingly output a first sensing signal. The first sensing signal includes the first capacitance variation value. In the current embodiment, a number of the at least one first water drop sensor 42 could be adjusted upon the required demand only if a location of the at least one first water drop sensor 42 corresponds to the location of the at least one first sensing area 222a. In the current embodiment, the water drop sensing module 40 is disposed on the inner surface of the outer housing 20 through sticking. In other embodiments, the water drop sensing module 40 could be disposed on the inner surface of the outer housing 20 through coating or embedding.

In the current embodiment, the at least one second water drop sensor 44 is at least one mutual capacitor sensor and includes a second sensing component 442, a third sensing component 444, and a second circuit board 446, wherein the second sensing component 442 and the third sensing component 444 are disposed on the second circuit board 446. A location of the at least one second sensing component 442 and a location of the at least one third sensing component 444 correspond to the location of the at least one second sensing area 222b. A second capacitance variation value is formed between the second sensing component 442 and the third sensing component 444. When the water drop 2 is in contact with the at least one second sensing area 222b corresponding to the location of the second sensing component 442 and the location of the third sensing component 444 of the at least one second water drop sensor 44, the water drop 2 correspondingly changes a coupling between the second sensing component 442 and the third sensing component 444 because of the water drop 2 being the conductor, so that a capacitance value between the second sensing component 442 and the third sensing component 444 changes by the second capacitance variation value to correspondingly output a second sensing signal. The second sensing signal includes the second capacitance variation value. In the current embodiment, a number of the at least one second water drop sensor 44 could be adjusted upon the required demand only if a location of the at least one second water drop sensor 44 corresponds to the location of the at least one second sensing area 222b. In addition, the at least one second water drop sensor 44 and the at least one second sensing area 222b could be omitted upon the required demand and the at least one first water drop sensor 42 and the at least one first sensing area 222a are disposed instead.

The control device 60 includes a controller 62a and a processor 64, wherein the controller 62 is electrically connected to the at least one first water drop sensor 42, the at least one second water drop sensor 44, and the processor 64. The processor 64 is electrically connected to the antenna control unit 122. When the first sensing component 422 of the at least one first water drop sensor 42 outputs the first sensing signal to the controller 62 and the controller 62 determines that the first capacitance variation value is equal to or greater than a predetermined value for a predetermined time, the controller 62 transmits the first sensing signal to the processor 64. The processor 64 transmits a first notifying signal to the antenna control unit 122 according to the first sensing signal. The antenna control unit 122 controls the antenna 124 to adjust the at least one device parameter according to the first notifying signal, e.g., raise the transmit power, reduce the transmission rate, reduce the transmission interval, and reduce the packet size, but not limited thereto. Therefore, through the controller 62 determining if the first capacitance variation value is greater than the predetermined value for the predetermined time, it could be known if it is raining outside the housing 100. In addition, through the processor 64 correspondingly controlling the antenna module 12 to adjust the at least one device parameter, a rain fade of the wireless signal could be improved. In addition, with the predetermined time, a misjudgment caused by another condition excluding the rainfall could be avoided. In the current embodiment, the controller 62 is a microcontroller and the processor 64 is a central processing unit, but not limited thereto. The predetermined value and the predetermined time could be adjusted upon the required demand. In other embodiments, the controller 62 could be omitted, a function of the controller 62 could be integrated into the processor 64 and the at least one first water drop sensor 42 and the at least one second water drop sensor 44 could be electrically connected to the processor 64.

When the second sensing component 442 outputs the second sensing signal to the controller 62 and the controller 62 determines that the second capacitance variation value is within a first predetermined range for the predetermined time, the controller 62 transmits the second sensing signal to the processor 64. The processor 64 transmits a second notifying signal to the antenna control unit 122 according to the second sensing signal. The antenna control unit 122 controls the antenna 124 to adjust the at least one device parameter by a first adjusting magnitude according to the second notifying signal. When the second sensing component 442 outputs the second sensing signal to the controller 62 and the controller 62 determines that the second capacitance variation value is within a second predetermined range for the predetermined time, the controller 62 transmits the second sensing signal to the processor 64. The processor 64 transmits the second notifying signal to the antenna control unit 122 according to the second sensing signal. The antenna control unit 122 controls the antenna 124 to adjust the at least one device parameter by a second adjusting magnitude according to the second notifying signal. A value of the second predetermined range is greater than a value of the first predetermined range. The second adjusting magnitude and the first adjusting magnitude are absolute values and the second adjusting magnitude is greater than the first adjusting magnitude.

Therefore, through the controller 62 determining if the second capacitance variation value is within the first predetermined range or the second predetermined range for the predetermined time, an intensity of the rainfall outside the housing 100 could be known. When the intensity of the rainfall is low (i.e., an area in which the water drop 2 is in contact with the at least one second sensing area 222b is low) and the second capacitance variation value is within the first predetermined range, the processor 64 controls the antenna module 12 to correspondingly adjust the at least one device parameter by the first adjusting magnitude, e.g., raise the transmit power, reduce the transmission rate, reduce the transmission interval, and reduce the packet size. When the intensity of the rainfall is great (i.e., the area in which the water drop 2 is in contact with the at least one second sensing area 222b is great) and the second capacitance variation value is greater than the first predetermined range and is within the second predetermined range, the processor 64 controls the antenna module 12 to correspondingly adjust the at least one device parameter by the second adjusting magnitude. In other words, to the greater rainfall, the adjustment with the second adjusting magnitude could be greater than the adjustment with the first adjusting magnitude, thereby precisely improving the rain fade of the wireless signal.

In an embodiment, when the antenna control unit 122 controls the antenna 124 to adjust the at least one device parameter according to the first notifying signal or the second notifying signal and then the water drop 2 is not in contact with the at least one first sensing area 222a or the at least one second sensing area 222b for a predetermined end time (i.e., in the predetermined end time, the controller 62 determines that the first capacitance variation value is less than the predetermined value or the second capacitance variation value is less than the first predetermined range, and the processor 64 does not receive the first sensing signal or the second sensing signal from the controller 62), the processor 64 correspondingly transmits an end notifying signal to the antenna control unit 122. The antenna control unit 122 controls the antenna 124 to stop adjusting the at least one device parameter and restore to the at least one initial device parameter. Therefore, when the rainfall stops, the wireless signal with the at least one adjusted initial device parameter could restore to the wireless signal with the at least one initial device parameter through the processor 64 transmitting the end notifying signal to the antenna control unit 122, so that the antenna module 12 could correspondingly restore to the initial operation state.

It must be pointed out that the embodiments described above are only some preferred embodiments of the present invention. All equivalent structures which employ the concepts disclosed in this specification and the appended claims should fall within the scope of the present invention.

What is claimed is:

1. A housing adapted to install an electronic device, wherein the electronic device has at least one device parameter; the housing comprises:
an outer housing which the electronic device is disposed in; an outer surface of the outer housing has at least one sensing area;
a water drop sensing module disposed on an inner surface of the outer housing corresponding to the at least one sensing area and located in the outer housing; the water drop sensing module comprises at least one first water drop sensor; when a water drop is in contact with the at least one sensing area corresponding to a location of the at least one first water drop sensor, the at least one first water drop sensor correspondingly outputs a first sensing signal; and
a control device electrically connected to the at least one first water drop sensor and the electronic device; the control device receives the first sensing signal and transmits a first notifying signal to the electronic device according to the first sensing signal; the electronic device adjusts the at least one device parameter according to the first notifying signal.

2. The housing as claimed in claim 1, wherein the electronic device is an antenna module; the antenna module comprises an antenna control unit and an antenna, wherein the antenna control unit is electrically connected to the control device and the antenna; the antenna has the at least one device parameter; the antenna control unit is adapted to control the antenna to adjust the at least one device parameter; the at least one device parameter is one of a transmit power, a transmission rate, a transmission interval, and a packet size or any combination of two or more thereof.

3. The housing as claimed in claim 2, wherein the at least one first water drop sensor is at least one self capacitor sensor and comprises a first sensing component; the first sensing component has a first capacitance variation value; the first sensing signal comprises the first capacitance variation value; when the first sensing component outputs the first sensing signal to the control device and the first capacitance variation value is greater than a predetermined value, the control device transmits the first notifying signal to the electronic device according to the first sensing signal.

4. The housing as claimed in claim 3, wherein when the first sensing component outputs the first sensing signal to the control device and the first capacitance variation value is greater than the predetermined value for a predetermined time, the control device transmits the first notifying signal to the electronic device according to the first sensing signal.

5. The housing as claimed in claim 2, wherein the water drop sensing module comprises at least one second water drop sensor; the at least one second water drop sensor is electrically connected to the control device; a location of the at least one second water drop sensor is not identical to the location of the at least one first water drop sensor; when the water drop is in contact with the at least one sensing area corresponding to the location of the at least one second water drop sensor, the at least one second water drop sensor correspondingly outputs a second sensing signal to the control device; the control device receives the second sensing signal and transmits a second notifying signal to the electronic device according to the second sensing signal; the electronic device adjusts the at least one device parameter according to the second notifying signal.

6. The housing as claimed in claim 5, wherein the at least one second water drop sensor is at least one mutual capacitor sensor and comprises a second sensing component and a third sensing component; a second capacitance variation value is formed between the second sensing component and the third sensing component; the second sensing signal comprises the second capacitance variation value; when the second sensing component outputs the second sensing signal to the control device and the second capacitance variation value is within a first predetermined range, the control device transmits a second notifying signal to the electronic device according to the second sensing signal; the electronic device adjusts the at least one device parameter by a first adjusting magnitude according to the second notifying signal; when the second sensing component outputs the second sensing signal to the control device and the second capacitance variation value is within a second predetermined range, the control device transmits the second notifying signal to the electronic device according to the second sensing signal; the electronic device adjusts the at least one device parameter by a second adjusting magnitude according to the second notifying signal; a value of the second predetermined range is greater than a value of the first predetermined range; the second adjusting magnitude is greater than the first adjusting magnitude.

7. The housing as claimed in claim 6, wherein when the second sensing component outputs the second sensing signal to the control device and the second capacitance variation value is within the first predetermined range for a predetermined time, the control device transmits the first notifying signal to the electronic device according to the second sensing signal; when the second sensing component outputs the second sensing signal to the control device and the second capacitance variation value is within the second predetermined range for the predetermined time, the control device transmits the first notifying signal to the electronic device according to the second sensing signal.

8. The housing as claimed in claim 2, wherein the outer surface of the outer housing has an emission surface; a wireless signal emitted by the antenna passes through the emission surface; the emission surface and the at least one sensing area are located on the same side of the outer housing.

9. The housing as claimed in claim 1, wherein the outer housing has a plurality of fins; the plurality of fins and the at least one sensing area are located on different sides of the outer housing.

10. The housing as claimed in claim 1, wherein when the electronic device adjusts the at least one device parameter and then the water drop is not in contact with the at least one sensing area for a predetermined end time, the control device correspondingly transmits an end notifying signal to the electronic device; the electronic device stops adjusting the at least one device parameter according to the end notifying signal.
